(19) United States
(12) Patent Application Publication
(10) Pub. No.: US 2019/0126609 A1
(43) Pub. Date: May 2, 2019

(54) INK-JET RECORDING APPARATUS AND DENSITY CORRECTION METHOD FOR INK-JET RECORDING APPARATUS

(71) Applicant: Konica Minolta, Inc., Chiyoda-ku Tokyo (JP)

(72) Inventor: Toshiyuki MIZUTANI, Hino-shi Tokyo (JP)

(21) Appl. No.: 16/157,666

(22) Filed: Oct. 11, 2018

(30) Foreign Application Priority Data
Nov. 1, 2017 (JP) 2017-211460

(51) Int. Cl. B41J 2/045

(52) U.S. Cl. CPC B41J 2/04536; B41J 2/04586

(57) ABSTRACT

A first density correction is executed by calculating drive conditions for a plurality of recording heads based on density information of the respective recording heads derived from reading the test chart density so that the drive conditions are set for the recording heads. After execution of the first density correction, a second density correction is executed by calculating a density unevenness correction value based on the density information derived from reading the density of the printed test chart by the recording section again so that the image data are corrected based on the density unevenness correction value.

### CROSS-REFERENCE TO RELATED APPLICATIONS

The present application claims priority under 35 U.S.C § 119(e) to Japanese Patent Application No. 2017-211460, filed on Nov. 1, 2017, is incorporated herein by reference in its entirety.

### BACKGROUND

### Technological Field

The present invention relates to an ink-jet recording apparatus, and a density correction method for the ink-jet recording apparatus.

### Description of the Related Art

There has been a known image forming apparatus of ink-jet type, that is, an ink jet recording apparatus configured to form an image by discharging (injecting) ink droplets from a plurality of nozzles to allow the ink to be deposited on a recording medium such as a paper while relatively moving the recording head having the nozzles relative to the recording medium. Aiming at improved recording speed, the ink-jet recording apparatus of the above-described type is configured through the image forming technique using the long head unit formed by arranging a plurality of recording heads in the direction intersecting the relative movement direction.

In the case of non-uniformity in the discharge amount of the ink droplets among the nozzles of the recording head of the ink jet recording apparatus, the density of the image formed on the recording medium (hereinafter referred to as a “formed image”) may become uneven, resulting in quality deterioration of the formed image. If a plurality of recording heads are employed, non-uniformity may also occur in the discharge amount of the ink droplets among those recording heads, which may cause the density unevenness of the formed image, resulting in deteriorated image quality. In order to prevent the above-described drawback, the ink-jet recording apparatus is configured to execute the density correction to suppress image quality deterioration owing to the density unevenness.

For example, the test pattern is printed, and density fluctuation in the direction along the nozzle array is read and output as disclosed in Japanese Unexamined Patent Application Publication No. 2006-159549 (Patent Literature 1). The feedback of the result of reading the density fluctuation is then applied to the drive voltage of the recording head per unit of nozzle or per unit of head so that the size of the dot (unit for forming the image) is changed for suppressing the image quality deterioration owing to the density unevenness. As disclosed in Japanese Unexamined Patent Application Publication No. 2010-83007 (Patent Literature 2), the test pattern is printed, allowing measurement of the density unevenness, and the feedback of the result of reading the test pattern is applied to the image data so that the number of dots per unit area is changed for suppressing the image quality deterioration owing to the density unevenness.

The former conventional art as described above, that is, the one for changing the dot size (dot diameter) by applying the feedback to the drive voltage of the recording head is the technique called AM (Amplitude Modulation) screening. The latter conventional art, that is, the one for applying the feedback to the image data to change the number of dots per unit area is the technique called FM (Frequency Modulation) screening.

### CITATION LIST

### Patent Literature

Patent Literature 1: Japanese Unexamined Patent Application Publication No. 2006-159549

Patent Literature 2: Japanese Unexamined Patent Application Publication No. 2010-83007

### SUMMARY

If the drive voltage of the recording head is preliminarily measured so that each discharge speed (injection speed) of the ink droplets from the nozzles becomes uniform, the discharge speed of the ink droplets cannot be measured using the ink to be actually employed in the state adapted to the actual usage environment where the recording head is installed in the ink-jet recording apparatus. Upon measurement of the drive voltage, the recording head to be measured is mounted on the injection measurement instrument for measuring the discharge speed at the controlled predetermined temperature using the liquid with predetermined viscosity.

That is, upon factory shipping of the recording head, the drive voltage is measured as the sensitivity voltage of each of the recording heads. Consequently, under the management of the ink, the recording medium, and the ink-jet recording apparatus, all of which are actually used, even if the measured drive voltage is set for the respective recording heads, the resultant density of the printed test chart with the same gray scale cannot necessarily be made uniform. Furthermore, even if the gray scale test chart is printed in the state where each density is different among the recording heads, and the printed data are corrected to make the density even, such a phenomenon as difference in the glossiness may occur in spite of the same density value.

As described above, the generally employed technique allows the density value to be made even, while forming images each with different gloss feel among the recording heads, resulting in deteriorated formed image quality.

It is an object of the present invention to provide the ink-jet recording apparatus capable of suppressing image quality deterioration owing to the gloss feel difference among the recording heads, and a density correction method for the ink-jet recording apparatus.

To achieve the above-described object, according to an aspect of the present invention, an ink-jet recording apparatus reflecting one aspect of the present invention includes a recording unit for printing an image on a recording medium by discharging ink droplets from a plurality of nozzles of a plurality of recording heads, an image reading section for reading a density of a density measuring test chart printed on the recording medium by the recording unit, and a control unit for controlling a density correction based on a result of reading by the image reading section. The control unit executes a function of a first density correction by calculating drive conditions for the respective recording heads based on density information of the recording heads derived from the test chart read by the image reading section so that the drive conditions are set for the recording heads, and a function of a second density correction by calculating a density unevenness correction value based on the density information derived from the test chart that has been printed by the recording unit again after execution of the first density correction, and read by the image reading section so that the image data are corrected based on the density unevenness correction value.

The present invention provides a density correction method for an ink-jet recording apparatus which includes a recording unit for printing an image on a recording medium by discharging ink droplets from a plurality of nozzles of a plurality of recording heads, and an image reading section for reading a density of a density measuring test chart printed on the recording medium by the recording unit so that a density correction is executed based on a read result of the image reading section. In the method, a first density correction and a second density correction are executed. The first density correction is executed by calculating drive conditions for the respective recording heads based on density information of the recording heads derived from the test chart read by the image reading section so that the drive conditions are set for the recording heads. The second density correction is executed by calculating a density unevenness correction value based on the density information derived from the test chart that has been printed by the recording unit again after execution of the first density correction, and read by the image reading section so that the image data are corrected based on the density unevenness correction value.

The first density correction is executed to change the condition for driving the recording head, and adjust the dot diameter so that the density is made uniform as a whole. Then, the second density correction is executed to correct the image data so that the dot ratio is adjusted. This may solve the problem of the glossiness non-uniformity exhibiting different gloss feel among the recording heads.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically showing an overall structure of an ink-jet recording apparatus according to an embodiment of the present invention;

FIG. 2 is a plan view of a head unit of the ink-jet recording apparatus according to the embodiment of the present invention in a view seen from a recording medium;

FIG. 3 is a block diagram of a structure of a control system of the ink-jet recording apparatus according to the embodiment of the present invention;

FIG. 4 is a view showing a relationship between a dot ratio and a 60° glossiness;

FIG. 5 is a function block diagram showing an example of a function structure relating to the density correction to be executed by the control unit in the control system of the ink-jet recording apparatus;

FIG. 6 is a flowchart representing a flow of the density correction process;

FIG. 7 is an explanatory view of a first density correction process for adjusting a discharge amount of ink droplets;

FIG. 8 is a view showing a relationship between a voltage correction value used for setting a drive voltage correction value, and an ink discharge amount;

FIG. 9 is a flowchart representing a flow of the first density correction operation; and

FIG. 10 is a flowchart representing a flow of a second density correction operation.

### DETAILED DESCRIPTION OF EMBODIMENTS

A mode for implementing the present invention (hereinafter referred to as an “embodiment”) will be described in detail referring to the drawings. It is to be noted that the present invention is not limited to the embodiment. In the following description and the respective drawings, the same elements or those each having the same function will be designated with the same codes, and repetitive explanations thereof, thus will be omitted.

### <Example of Structure of Ink-Jet Recording Apparatus>

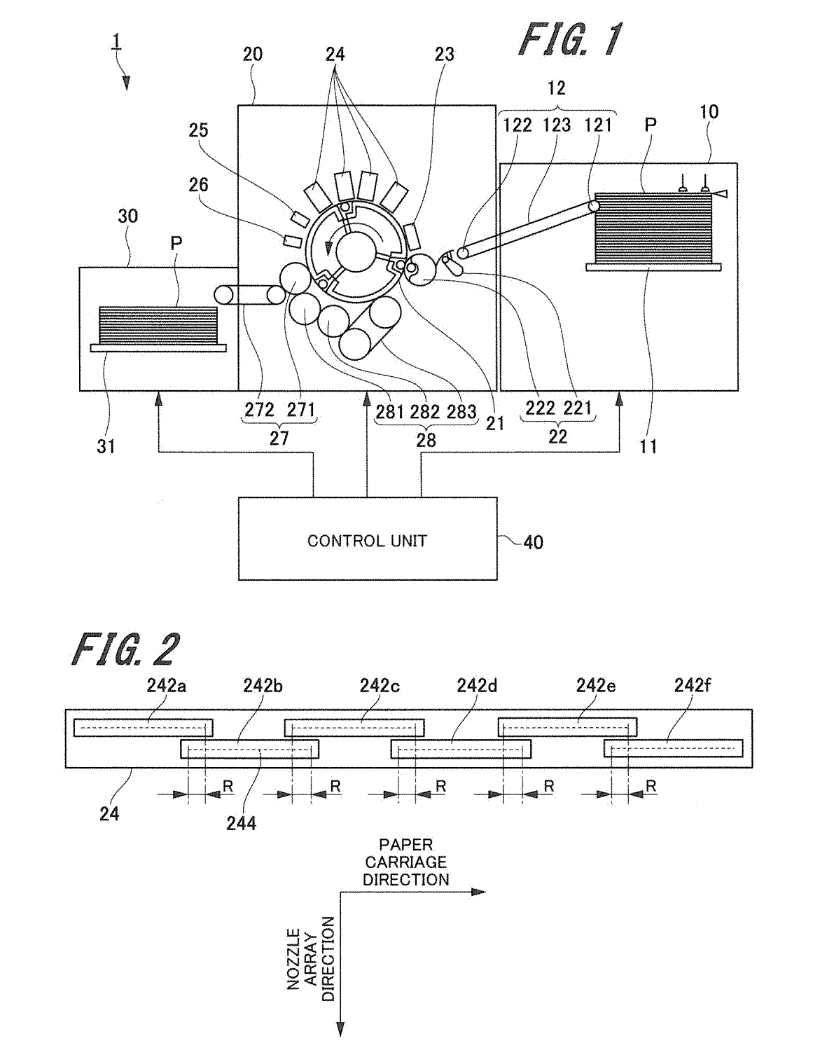

An example of the structure of the ink-jet recording apparatus will be described referring to FIG. 1. FIG. 1 is a view schematically showing an overall structure of the ink-jet recording apparatus according to an embodiment of the present invention.

An ink-jet recording apparatus 1 shown in FIG. 1 is an image forming apparatus configured to discharge (inject) ink droplets from a plurality of nozzles installed in the recording head, and form an image on a recording paper P as an example of the recording medium. The ink-jet recording apparatus 1 is of color format type for overlaying four color inks of yellow (Y), magenta (M), cyan (C), and black (K).

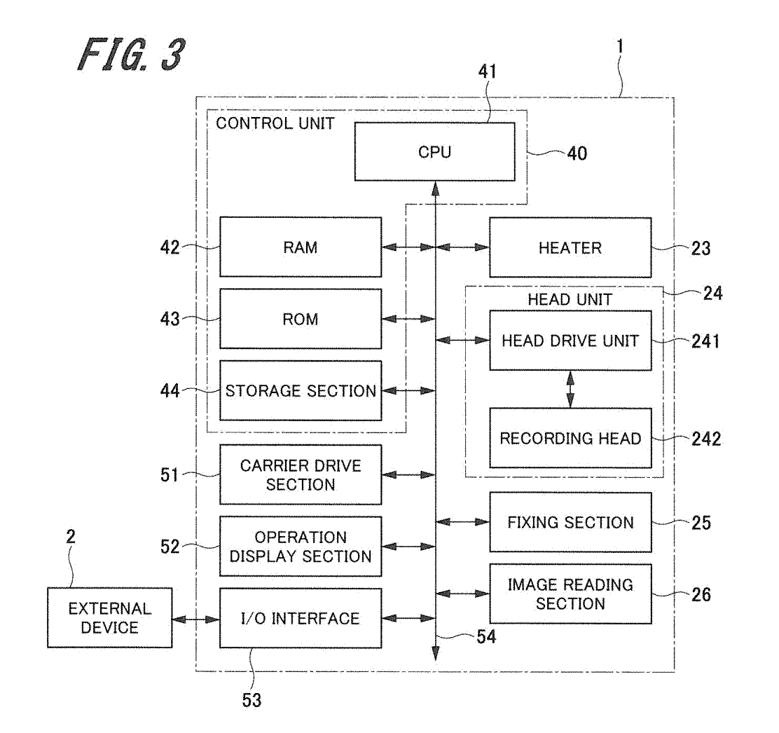

The ink-jet recording apparatus 1 includes a paper feed unit 10, an image forming unit 20, a paper discharge unit 30, and a control unit 40. The ink-jet recording apparatus 1 forms (records) an image based on image data input from an external device 2 (see FIG. 3) on the recording paper P.

The paper feed unit 10 includes a paper feed tray 11 and a paper supply section 12. The paper feed tray 11 is a plate-like member which allows placement of the recording paper P. The paper feed tray 11 is disposed so as to be vertically moveable in accordance with the number of sheets of the placed recording paper P. The uppermost recording paper P of those placed on the paper feed tray 11 is retained at a position to be carried by the paper supply section 12.

The paper supply section 12 includes a plurality of rollers (two rollers in the embodiment) 121, 122, and a carrier belt 123. The carrier belt 123 is of endless type having both ends in the longitudinal direction connected. The carrier belt 123 is stretched to be laid between the rollers 121 and 122. One of the rollers 121 and 122 is rotatably driven so that the carrier belt 123 moves cyclically between the rollers 121 and 122, and accordingly, the recording paper P placed on the carrier belt 123 is carried.

The paper supply section 12 includes a not shown drive section for rotatably driving the rollers 121, 122, and a supply section for delivering the uppermost recording paper P placed on the paper feed tray 11 to the carrier belt 123. The paper supply section 12 carries the recording paper P on the carrier belt 123 toward the image forming unit 20 for paper supply.

The image forming unit 20 includes an image forming drum 21, a delivery unit 22, a heater 23, a head unit 24, a fixing section 25, an image reading section 26, a paper ejection section 27, and a paper reversing section 28.

The image forming drum 21 is formed into a cylindrical shape. The image forming drum 21 is rotatably driven by a not shown drive motor to rotate counterclockwise. The recording paper P supplied from the paper feed unit 10 is supported on the outer circumferential surface of the image forming drum 21. The image forming drum 21 rotates to carry the recording paper P toward the paper discharge unit 30. The heater 23, the head unit 24, the fixing section 25, and the image reading section 26 are arranged while facing the outer circumferential surface of the image forming drum 21.

The delivery unit 22 is disposed between the paper supply section 12 of the paper feed unit 10, and the image forming drum 21. The delivery unit 22 includes a pawl part 221, a cylindrical delivery drum 222, and the like. The pawl part 221 supports one end of the recording paper P carried by the paper supply section 12. The delivery drum 222 guides the recording paper P supported with the pawl part 221 to the image forming drum 21. The recording paper P is delivered to the outer circumferential surface of the image forming drum 21 from the paper supply section 12 via the delivery unit 22.

The heater 23 is disposed at the downstream side of the delivery drum 222 in the direction for carrying the recording paper P. Electricity is applied to the heater 23 provided with, for example, heating wires for heat generation. The heater 23 is controlled by the control unit 40 to heat the recording paper P which passes around the heater 23 while being supported with the image forming drum 21 so that the recording paper P has the predetermined temperature.

A not shown temperature sensor is disposed near the heater 23. The temperature sensor detects the temperature of the area around the heater 23. The control unit 40 controls the temperature of the heater 23 based on the temperature information detected by the temperature sensor.

The head units 24 are disposed at the downstream side of the heater 23 in the direction for carrying the recording paper P. The four head units 24 are disposed corresponding to colors of yellow (Y), magenta (M), cyan (C), and black (K), respectively. The four head units 24 corresponding to yellow, magenta, cyan, black are arranged sequentially from the upstream side in the direction for carrying the recording paper P.

The head unit 24 is a recording unit for printing an image (forming an image) on the recording paper P by discharging ink droplets from the respective nozzles of the recording heads. The head units 24 are set to have a dimension (page width) for entirely covering the recording paper P in the direction orthogonal to the one for carrying the recording paper P (width direction of the recording paper P). In other words, the ink-jet recording apparatus 1 according to the embodiment is of line head type for a one-pass system, which is configured to form an image by allowing the head unit 24 to scan the recording paper P only once. The one-pass system is excellent from the perspective of high-speed printing. Each of the four head units 24 has the same structure except the color of the ink to be discharged. The head unit 24 will be described later in more detail.

The fixing section 25 is disposed at the downstream side of the four head units 24 in the direction for carrying the recording paper P. For example, the fluorescent tube for irradiating ultraviolet rays such as the low pressure mercury lamp may be applied to the fixing section 25. The fixing section 25 irradiates ultraviolet rays to the recording paper P carried by the image forming drum 21, and solidifies the droplets of the ink discharged onto the recording paper P. In the above-described manner, the fixing section 25 fixes the image formed on the recording paper P.

In addition to the low pressure mercury lamp, the fluorescent tube for irradiating ultraviolet rays may be exemplified by the mercury lamp at the operation pressure ranging from several hundreds Pa to 1 MPa, the light source usable as the germicidal lamp, the cold cathode tube, the ultraviolet laser light source, the metal halide lamp, the light emitting diode and the like. Among those described above, it is preferable to employ the light source as the fluorescent tube, which is capable of irradiating ultraviolet rays with higher illuminance while keeping the low power consumption (for example, the light emitting diode).

The fixing section 25 may be arbitrarily exemplified by the device capable of irradiating energy lines functioning for solidifying the ink in accordance with its property without being limited to the one for irradiating ultraviolet rays. The light source may also be replaceable in accordance with the wavelength of the energy line. The fixation method implemented by the fixing section may be exemplified by the methods for drying the ink droplets by heating the paper, providing the liquid for chemically changing the ink droplets, or any other methods.

The image reading section 26 is disposed at the downstream side of the position at which the image is fixed by the fixing section 25 in the direction for carrying the recording paper P, while facing a drum surface of the image forming drum 21. The image reading section 26 is configured to read density of the image formed on the recording paper P to be carried by the image forming drum 21. The image includes the density measuring test chart to be described later. The image reading section 26 transmits the read image data to the control unit 40 as image pickup data.

The image reading section 26 is formed by combining the light source for irradiating the recording paper P carried by the image forming drum 21 with light, and a sensor section for detecting intensity of the reflection light from the subject recording paper P based on the light emitted from the light source to the recording paper P. The sensor section is a line sensor configured by arranging a plurality of detection elements (pixels) in the direction orthogonal to the direction for carrying the recording paper P (width direction of the recording paper P).

The line sensor is capable of obtaining the image formed on the recording paper P for each of a plurality of wavelength components, for example, three wavelengths corresponding to red (R), green (G), and blue (B). It is possible to employ an image pickup element of CCD (Charge Coupled Device) type, the image pickup element of CMOS (Complementary Metal Oxide Semiconductor) type, and the like as the detection element of the line sensor. As the sensor section of the image reading section 26, it is possible to use an area sensor formed by two-dimensionally arranging the image pickup elements instead of the line sensor without being limited to the above-described structure.

Each interval among the detection elements (pixels) which constitute the image reading section 26 is set to be wider than each interval among the nozzles 244 of the recording head 242. That is, a reading resolution (resolving power) in the direction along the nozzle array (hereinafter referred to as a “nozzle array direction”) of the image reading section 26 is lower (coarser) than a recording resolution of the recording head 242. In other words, the relationship of the reading resolution of the image reading section 26 is lower than the recording resolution of the recording head 242.

The paper ejection section 27 and the paper reversing section 28 are disposed at the downstream side of the image reading section 26 in the direction for carrying the recording paper P. The paper ejecting section 27 carries the recording paper P which has been carried by the image forming drum 21 toward the paper discharge unit 30.

The paper ejection section 27 includes a cylindrical separation drum 271 and an ejection belt 272. The separation drum 271 separates the recording paper P supported with the image forming drum 21 from the outer circumferential surface of the image forming drum 21. The separation drum 271 guides the recording paper P either to the ejection belt 272 or the paper reversing section 28.

The separation drum 271 guides the recording paper P to the ejection belt 272 upon execution of the face-up paper discharge for one-side image formation. The separation drum 271 guides the recording paper P to the paper reversing section 28 upon execution of the face-down discharge for the one-side image formation, and double-side image formation.

Likewise the carrier belt 123 of the paper supply section 12, the ejection belt 272 has the endless structure. The ejection belt 272 is rotatably supported with the rollers so that the recording paper P delivered by the separation drum 271 is transmitted to the paper discharge unit 30.

The paper reversing section 28 includes a plurality of reversing rollers 281, 282, and a reversing belt 283. Upon execution of the face-down paper discharge, the recording paper P which has been guided by the separation drum 271 is reversed upside down, and is carried to the paper ejection section 27. The recording paper P is carried by the paper ejection section 27 to the paper discharge unit 30 while having the surface on which the image is formed directed downward in the up-and-down direction.

Upon execution of the double-side image formation, the paper reversing section 28 reverses the recording paper P which has been guided by the separation drum 271 upside down, and then further carries the recording paper to the outer circumferential surface of the image forming drum 21 again. The recording paper P is carried by the image forming drum 21 to pass around the heater 23, the head units 24, the fixing section 25, and the image reading section 26 again.

The paper discharge unit 30 stores the recording paper P which has been fed from the image forming unit 20 by the paper ejection section 27. The paper discharge unit 30 includes a flat plate-like paper discharge tray 31. The paper discharge unit 30 places the recording paper P on which the image is formed on the paper discharge tray 31.

### [Example of Head Unit Structure]

The example of the structure of the head unit 24 will be described referring to FIG. 2. FIG. 2 is a plan view representing the head unit 24 of the ink-jet recording apparatus 1 according to the embodiment of the present invention in the view seen from the paper.

The head unit 24 includes a plurality of recording heads 242a to 242f (in the embodiment, six recording heads which may be collectively referred to as the recording head 242). FIG. 2 schematically shows positions of the nozzles 244 of the recording head 242. The nozzles 244 are arranged in the direction intersecting (in the embodiment, orthogonal direction) the direction for carrying the recording paper P (paper carrying direction). The direction in which those nozzles 244 are arranged will be referred to as a nozzle array direction. The six recording heads 242a to 242f are arranged in a zigzag form so that the arrangement ranges in the nozzle array direction are partially overlapped. Along the nozzle array direction, the nozzles 244 of the odd-numbered recording heads 242a, 242c, 242e are aligned on the same straight line, and the nozzles 244 of the even-numbered recording heads 242b, 242d, 242f are aligned on the same straight line.

A pair of adjacent recording heads 242 among the six recording heads 242a to 242f is arranged so that the nozzles 244 (nozzle group) at one proximal end of one of the recording heads 242 are positionally shifted from the nozzles at a proximal end of the other recording head 242 in a range where those nozzles are overlapped in the nozzle array direction. In other words, the six recording heads 242a to 242f include the ranges in which the respective nozzle groups are overlapped in the nozzle array direction so that the ink dischargeable ranges in the nozzle array direction are sequentially interconnected. In each of the ranges in which the nozzle groups of the recording heads 242a to 242f are arranged while having partially overlapped, overlapped ranges R (joint part) are set. In each of the overlapped ranges R, the ink is complementarily discharged from the respective nozzles of the pair of recording heads 242 having their nozzles disposed in the overlapped ranges R. In this embodiment, the whole range in which the nozzle groups of the pair of recording heads 242 are disposed while being partially overlapped may be set to the overlapped range R.

The number and the arrangement of the recording heads 242 are not limited to the above-described example. The structure may be formed by arranging eight or more recording heads 242.

The recording head 242 is an ink-jet head provided with a plurality of recording elements including the nozzles 244 for discharging ink droplets onto the recording paper P. In addition to the nozzles 244, the recording element includes a pressure chamber for storing the ink, and a piezoelectric element disposed on a side wall of the pressure chamber. The element is configured to have the nozzles 244 communicated with the pressure chamber. The drive voltage as the drive condition, which deformably operates the piezoelectric element is supplied from a head drive unit 241 (see FIG. 3) to the recording head 242 in accordance with the pixel value of the image data.

As the piezoelectric element is deformably operated, the pressure chamber is deformed in accordance with the drive voltage from the head drive unit 241 to change the inner pressure of the pressure chamber. Then the nozzles 244 communicated with the pressure chamber discharge the ink droplets. In the above-described state, the ink droplets by the amount in accordance with the pixel value of the image data are discharged from the nozzles 244 of the respective recording heads 242 onto the recording paper P so that an image is formed on the recording paper P supported with the image forming drum 21.

### <Example of Control System Structure>

The structure of the control system of the ink-jet recording apparatus 1 will be described referring to FIG. 3. FIG. 3 is a block diagram showing the structure of the control system of the ink-jet recording apparatus 1 according to an embodiment of the present invention.

As FIG. 3 shows, the ink-jet recording apparatus 1 includes the control unit 40. The control unit 40 includes a CPU (Central Processing Unit) 41, a RAM (Random Access Memory) 42 used as a work area for the CPU 41, and a ROM (Read Only Memory) 43 for storing the program and the like to be executed by the CPU 41, for example.

The control unit 40 includes a storage section 44 as a mass storage device such as a hard disk drive (HDD). The storage section 44 stores image data received from the external device 2, image data based on the image read by the image reading section 26 from the recording paper P, and data (ink discharge amount data) relating to the amount of the ink droplets discharged from the nozzle groups of the recording heads 242. The data are used for density correction to be described below.

The ink-jet recording apparatus 1 includes a carrier drive section 51 for driving the carrier system such as the image forming drum 21, the paper ejection section 27, and the paper reversing section 28, an operation display section 52, and an I/O interface 53.

The CPU 41 of the control unit 40 is connected to the heater 23, the head units 24, the fixing section 25, the image reading section 26, the RAM 42, the ROM 43, and the storage section 44 via a system bus 54 so as to control the ink-jet recording apparatus 1 as a whole. The CPU 41 is connected to the carrier drive section 51, the operation display section 52, and the I/O interface 53 via the system bus 54.

The operation display section 52 is constituted using a touch panel formed by combining a panel type display device such as a liquid crystal display (LCD) device and an organic EL (Electro Luminescence) display device, and a position input device such as a touch pad. The operation display section 52 displays an instruction menu for the user, and information of the obtained image data. Furthermore, the operation display section 52 includes a plurality of keys as an input section for receiving inputs of data such as various instructions, characters, and figures through the user's key operation.

The I/O interface 53 is connected to the external device 2 such as a PC (personal computer) and a facsimile machine. The I/O interface 53 receives the image data from the external device 2, and supplies the received image data to the control unit 40 via the system bus 54. The control unit 40 subjects the image data input through the I/O interface 53 to the image processing, for example, the shading correction, the image density adjustment, and the image compression as needed.

The head unit 24 receives the image data which have been processed by the control unit 40 for forming a predetermined image on the recording paper P based on the image data. Specifically, the head unit 24 applies the drive voltage in accordance with the pixel value of the image data to the recording heads 242 from the subject head drive unit 241 which is driven under the control of the control unit 40.

As described above, the ink droplets will be discharged (injected) through the nozzles 244 of the recording heads 242 by the amount in accordance with the pixel value of the image data. The ink droplets land on the predetermined position on the recording paper P so that the image is formed. The image formed on the recording paper P is read by the image reading section 26. The image data (image pickup data) based on the image read by the image reading section 26 are stored in the storage section 44 under the control of the control unit 40.

For the use of the ink discharged from the nozzles 244 of the recording head 242, it is possible to use a hot melt type ink composition made from a wax that is solid at a room temperature, and a phase-change type ink composition having the phase changed in the gel state on the recording medium. It is possible to adjust the amount of the ink droplets discharged from the nozzles 244 of the recording head 242 by correcting the magnitude of the voltage value (voltage amplitude) of the drive voltage applied from the head drive unit 241 to the recording head 242 and/or the time period for application of the drive voltage.

The magnitude of the drive voltage value may be corrected by changing the magnitude of the voltage value of the power supply voltage applied to the head drive unit 241. Alternatively, the magnitude of the drive voltage value may be corrected by selecting one of a plurality of different voltage values which have been input to the head drive unit 241. The time period for applying the drive voltage may be corrected by changing drive voltage pattern data which are referred upon application of the drive voltage from the head drive unit 241 to the recording head 242.

### <Density Unevenness>

When the nozzles 244 of the respective recording heads 242 of the above-structured ink-jet recording apparatus 1 discharge the ink droplets in accordance with the drive voltage each having the same voltage value, preferably, the discharge amount of the ink droplets (discharge liquid amount) is uniform. However, the amount of the ink droplets may be non-uniform among the recording heads 242 or among the nozzles 244 of the respective recording heads 242 as a result of either the inner temperature unevenness among the recording heads 242, or the property unevenness among the recording elements of the recording heads 242.

The difference of the discharge amount of the ink droplets among the nozzles 244 of the recording head 242 may cause the density unevenness in the image formed on the recording paper P. The density unevenness may lead to deterioration in quality of the formed image. In the case of the plurality of recording heads 242, each amount of the ink droplets discharged from the respective recording heads 242 becomes non-uniform. The non-uniformity in the discharge amount among the recording heads 242 may also cause the density unevenness of the formed image, leading to deterioration in quality of the formed image.

The recording heads 242 are arranged across the page width in the nozzle array direction so as to configure the head unit 24. The examination will be made with respect to the density unevenness observed in the gray scale test chart printed by the head unit 24.

Each of the nozzles 244 of the individual recording heads 242 discharges the ink droplets at the different speed, causing the error of the discharge speed between the adjacent nozzles 244. There may be the difference in the discharge speed at the low frequency in the nozzle array direction. The change in the discharge speed makes the discharge amount of the ink droplets (discharge liquid amount) variable, resulting in the density unevenness both at high frequency and low frequency.

It is possible to cope with the density unevenness by partially changing the drive voltage as the drive condition in the recording head 242. However, it is necessary to set the drive condition for each of the nozzles in order to make the respective discharge amounts of the ink droplets uniform among the nozzles. The resultant circuit structure of the head drive unit 241 becomes complicated, resulting in cost increase.

### <Glossiness Unevenness>

If the drive voltage applied to the recording head 242 is preliminarily measured to make the discharge speeds of the ink droplets from the respective nozzles 244 uniform, the discharge speeds of the ink droplets cannot be measured using the ink to be actually employed in the state adapted to the actual usage environment where the recording heads 242 are installed in the ink-jet recording apparatus 1. Upon measurement of the drive voltage, the recording head to be measured is loaded in the injection measuring instrument for measurement of the discharge speed under the predetermined temperature control using liquid with the predetermined viscosity.

That is, upon factory shipping of the recording heads 242, the drive voltage as the drive condition is measured in the form of the sensitivity voltage of each of the recording heads 242. Accordingly, under management of the actually usable ink, the recording medium, and the ink-jet recording apparatus, the density of the printed test chart with the same gray scale may not be necessarily made uniform even if the measured drive voltage is set to the respective recording heads 242. If the gray scale test chart is printed in the state where the density is different among the recording heads 242, and the resultant printed data (image data) are corrected to make the density uniform, there may cause the glossiness unevenness exhibiting different gloss feel in spite of the same density value.

Especially, if the image is formed using the ink, the droplets of which are solidified on the recording paper P like the phase-change ink for fixation on the recording paper P in operating the ink-jet recording apparatus 1 of one-pass type, the droplet gathering may not only deteriorate the particle condition of the dot but also cause sense of incongruity of the glossiness of the formed image. More specifically, in the above-described case, the ink dot of the image formed on the recording paper P is brought into the soft wax-like condition, and the dot rises up to unintentionally form a mass, resulting in a locally high dot ratio. The dot ratio represents the ratio of the dot-forming pixels to a plurality of pixels which constitute the image data as the source data of the image to be formed on the recording paper P.

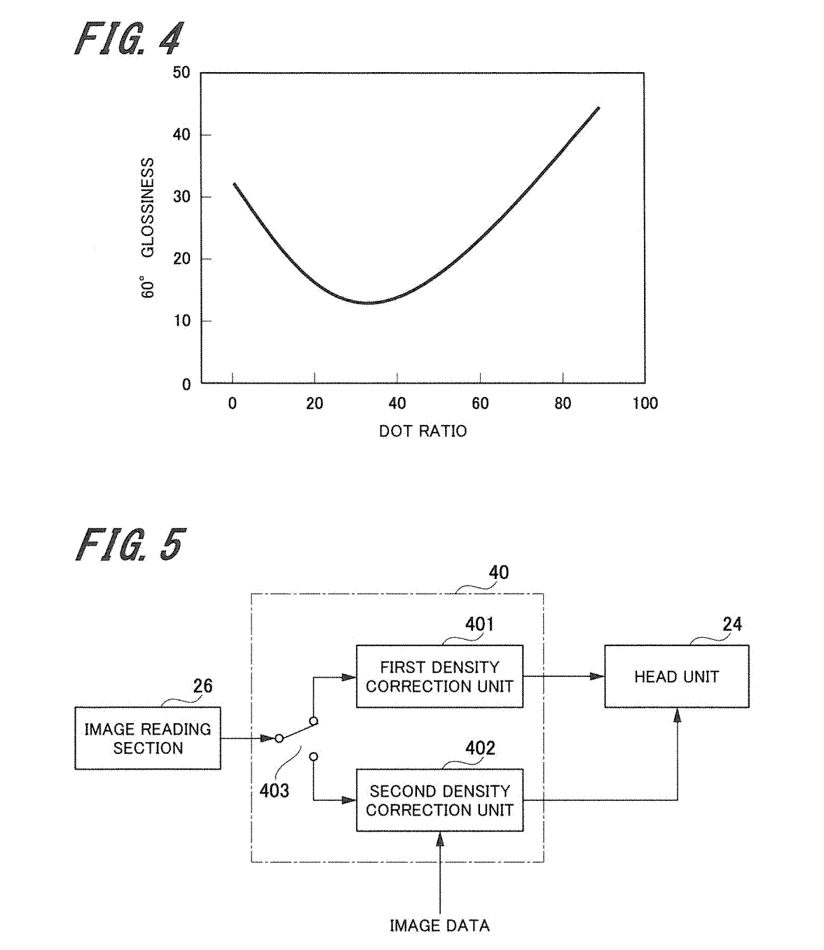

FIG. 4 shows a relationship between the dot ratio and 60° glossiness. FIG. 4 clearly shows a correlation between the dot ratio and the 60° glossiness. Specifically, the 0% dot ratio represents the glossiness of the paper surface, and the 100% dot ratio represents the glossiness of the ink surface. FIG. 4 shows the decline of the 60° glossiness around the 30% dot ratio. Such a decline is thought to be caused by dispersion at the edge of the dot. The color depth is proportional to the coverage factor. Meanwhile, the density is correlated with the coverage factor of the dot. When making the density uniform in accordance with the dot ratio in the case of the different dot diameter, the glossiness becomes uneven although the density of the image formed on the recording paper P is uniform as a whole. The resultant glossiness unevenness may be the cause of deterioration in quality of the image formed on the recording paper P.

### DESCRIPTION OF EMBODIMENTS

In the embodiment, focusing on the correlation between the glossiness and the dot ratio (the number of dots) rather than the correlation between the glossiness and the dot diameter (dot size), an idea has occurred to improve the glossiness unevenness under the control of the control unit 40. Specifically, the condition for driving the recording heads 242 is changed to adjust the dot diameter, in other words, the discharge amount of the ink droplets (liquid amount) so that the density between the adjacent recording heads 242 becomes uniform at the same dot ratio. After adjustment of the dot diameter, the image data are corrected with respect to the density undergoing a gentle change in the respective recording heads 242 so that the dot ratio is adjusted.

As described above, focusing on the correlation of the glossiness with the dot ratio rather than with the dot diameter, the embodiment is configured to change the condition for driving the recording heads 242 to adjust the dot diameter, and to adjust the dot ratio by correcting the image data. This makes it possible to suppress deterioration of image quality owing to the glossiness difference among the recording heads 242. It is possible to realize both high quality and natural gloss feel of the image formed on the recording medium.

Described below is a specific example for density correction to solve especially the glossiness unevenness under the control of the control unit 40.

### First Example

A first example will be described with respect to the specific function structure of the control unit 40 which executes the control for the density correction. FIG. 5 is a function block diagram showing an exemplary function structure for the density correction executed by the control unit 40 of the control system of the ink-jet recording apparatus 1. As FIG. 5 shows, the control unit 40 includes the respective function parts of a first density correction unit 401, a second density correction unit 402, and a selector switch 403. The respective functions of the first density correction unit 401, the second density correction unit 402, and the selector switch 403 may be implemented under the control of the CPU 41 which constitutes the control unit 40, for example. The selector switch 403 serves to switch the mode between a first mode for supplying the result of the density of the test chart read by the image reading section 26 to the first density correction unit 401, and a second mode for supplying the result of the density of the test chart read by the image reading section 26 to the second density correction unit 402.

In the first mode, upon correction executed by the first density correction unit 401, the density measuring test chart, for example, the gray scale test chart is printed on the recording paper P by the head unit 24 through each nozzle group which sets the same drive conditions in the recording heads 242. The first density correction unit 401 receives the result of density of the test chart read by the image reading section 26 as the density information of the recording heads 242. Receiving the density information of the recording heads 242, the first density correction unit 401 calculates the respective drive conditions for the recording heads 242, for example, the drive voltage correction values based on the density information so that the calculated values are set for the recording heads 242 of the head unit 24.

After correction executed by the first density correction unit 401, the head unit 24 prints the density measuring test chart on the recording paper P again. It is possible to use either the same density measuring test chart which has been printed in the first processing, or the different test chart as the one to be printed after the correction executed by the first density correction unit 401. It is arbitrarily determined whether the same or the different test chart is used.

In the second mode, the second density correction unit 402 receives the density information derived from the image reading section 26 which has read the density of the density measuring test chart that reflects the result of the correction made by the first density correction unit 401. Receiving the density information, the second density correction unit 402 calculates the density unevenness correction value based on the density information, and corrects the image data in accordance with the density unevenness correction value. The second density correction unit 402 supplies the corrected image data as printed data to the respective recording heads 242 of the head unit 24. Each number of times of correction operations executed by the first density correction unit 401 and the second density correction unit 402 may be set to once or more.

The ink-jet recording apparatus 1 according to the embodiment, which includes the first density correction unit 401 and the second density correction unit 402 is configured to set the reading resolution of the image reading section 26 to be lower than the recording resolution of the recording head 242 (reading resolution <recording resolution). This is grounded on the circumstance that the image reading section 26 is required to exhibit high performance so as to realize the reading resolution equivalent to the recording resolution, resulting in the cost increase. The reading resolution of the image reading section 26, which is set to be lower than the recording resolution of the recording head 242 may cause the failure. Such a failure is thought to be caused by moire generated upon down-sampling, which interferes with accurate measurement of the density. The image reading section 26 according to the present example employs an optical low pass filter so as to suppress the moire. The optical low pass filter cuts the component at the frequency higher than the Nyquist frequency of the image reading section 26 so as to obtain the low resolution image with less moire. This makes it possible to accurately execute the density correction regardless of the reading resolution (resolving power) of the image reading section 26 for reading the density of the density measuring test chart. The gray scale test chart as the density measuring test chart is printed (recorded) with a plurality of gradations so as to allow calculation of conditions for driving the respective recording heads 242 based on a plurality of density information data.

### Second Example

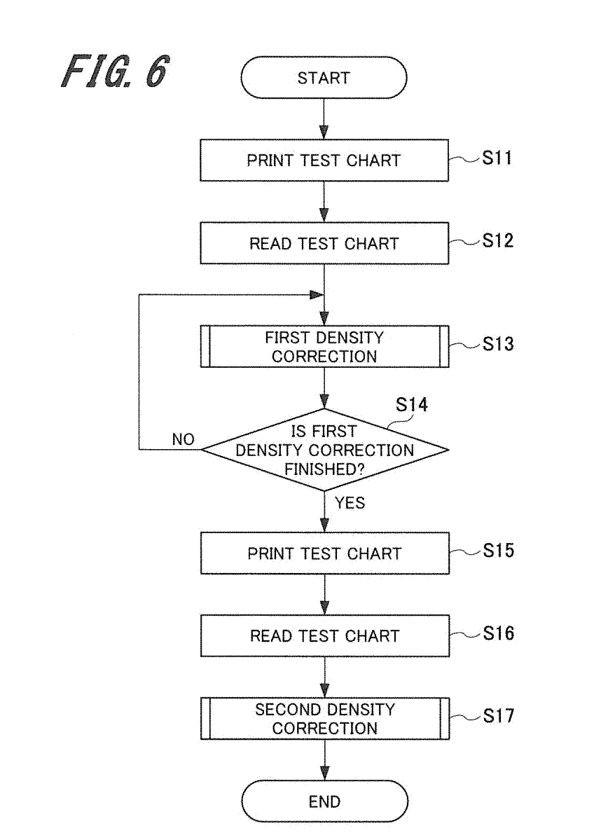

A second example describes an exemplified density correction process. FIG. 6 is a flowchart representing a flow of the density correction process. The density correction process is executed under the control of the control unit 40, more specifically, under the control of the CPU 41 constituting the control unit 40 (see FIG. 3).

The density correction process is executed upon an input operation on the operation display section 52, for example, in response to the user's input operation to instruct execution of the density correction process. The above-described density correction process will be executed through operation by the user if the recording heads 242 of the head unit 24 are partially or entirely replaced.

Upon execution of the density correction process, the CPU 41 controls the head unit 24 to print the gray scale test chart, for example, on the recording paper P as the density measuring test chart (step S11).

In step S11, the CPU 41 outputs a control signal to the carrier drive section 51. The carrier drive section 51 then drives the image forming drum 21 so as to be rotated to carry the recording paper P. The CPU 41 supplies the control signal which contains the image data of the test chart stored in the ROM 43 to the head drive unit 241 which in turn outputs a drive voltage to the recording head 242 at an appropriate timing in accordance with the rotation of the image forming drum 21. Then the ink droplets are discharged from the nozzles 244 of the recording head 242 onto the recording paper P which has been carried by the image forming drum 21 so that the test chart is printed (formed) on the recording paper P.

The CPU 41 controls the image reading section 26 to read the density of the test chart printed on the recording paper P (step S12). Specifically, the CPU 41 allows the image reading section 26 to read the density of the test chart printed on the recording paper P while allowing the image forming drum 21 to carry the recording paper P so as to obtain the image pickup data read by the image reading section 26, and allow the storage section 44 to store the data.

The CPU 41 executes a first density correction operation based on the density information of the test chart given from the image reading section 26 (step S13). In the first density correction operation, the respective conditions for driving the recording heads 242, specifically, the drive voltage correction values are calculated based on the test chart density information so as to execute the process for setting those values for the respective recording heads 242. As described above, the dot diameter, that is, the discharge amount (liquid amount) of the ink droplets is adjusted. The detailed explanation of the process will be described later.

The CPU 41 determines whether or not the first density correction operation has been finished (step S14). If the operation has not been finished (NO in S14), the process returns to step S13. If the operation has been finished (YES in S14), the head unit 24 is controlled again to print the density measuring test chart on the recording paper P (step S15). Then the CPU 41 controls the image reading section 26 to read the density of the test chart printed on the recording paper P (step S16).

The CPU 41 executes a second density correction operation based on the test chart density information given from the image reading section 26 (step S17). In the second density correction operation, the density unevenness correction value is calculated based on the test chart density information, based on which the image data are corrected so that the dot ratio is adjusted. The detailed explanation of the process will be described later.

### (First Density Correction Operation)

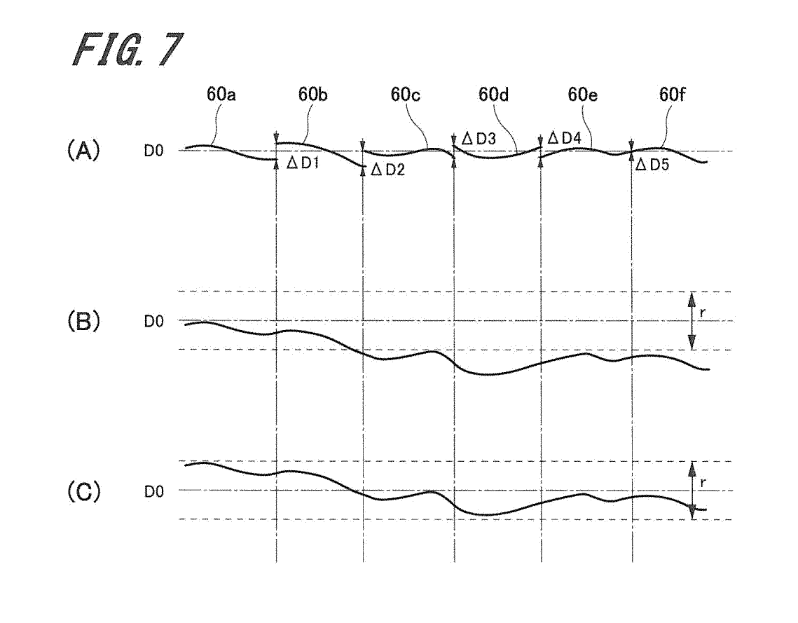

The first density correction operation is executed to adjust the discharge amount of the ink droplets discharged from the nozzles 244 of the recording head 242. FIG. 7 is an explanatory view of the process executed in the first density correction to adjust the discharge amount of the ink droplets.

FIGS. 7A to 7C graphically represent the transition of the predictive values of the ink discharge amount to be calculated using the image read values derived from the image reading section 26 based on voltage correction values which are set in the respective stages of the processing operation for adjusting the discharge amount of the ink droplets (which may be referred to as “ink discharge amount”). The drawing shows the predictive values of the ink discharge amounts 60a to 60f from the nozzle groups of the recording heads 242 when printing the density measuring test chart.

The first density correction operation is executed to obtain each average value of the ink discharge amounts 60a to 60f corresponding to the respective recording heads 242 based on the ink discharge amount data stored in the storage section 44. Based on each difference between the average values of the ink discharge amounts 60a to 60f, and a predetermined reference value D0 of the ink discharge amount, the drive voltage correction values corresponding to the respective recording heads 242 are set so that each of the average values of the ink discharge amounts 60a to 60f corresponding to the respective recording heads 242 coincides with the reference value D0. An LUT (not shown) representing a relationship between the ink discharge amount and the image read value derived from the image reading section 26 is preliminarily held. The predictive value represents the value derived from converting the image read value into the liquid amount. FIG. 7A shows the predictive value of the ink discharge amount based on the thus set voltage correction values in the state where the head unit 24 prints the density measuring test chart.

The reference value D0 of the ink discharge amount is the value at the center of a reference range r of the ink discharge amount in accordance with the density of the density measuring test chart used for generating the ink discharge amount data. The reference range r represents the range of the ink discharge amount which allows printing of the image with appropriate quality corresponding to the density of the density measuring test chart. The upper limit value and the lower limit value of the reference range r may be determined as described below.

If the ink discharge amount is too large, light rays emitted from a light emitting element of the fixing section 25 may be absorbed around the surface of the ink droplet discharged onto the recording paper P while failing to reach the inside of the ink droplet, causing the problem of insufficient solidification of the ink. The upper limit value of the reference range r is set to secure sufficient solidification of the ink.

Meanwhile, if the ink discharge amount is too small, it becomes impossible to appropriately compensate insufficiency of the ink resulting from the defective nozzle failing to discharge the ink by increasing the discharge amount of the ink from the nozzle near the defective nozzle. The lower limit value of the reference range r is determined to secure compensation of the insufficiency of the ink discharge amount owing to the defective nozzle.

The voltage correction value is set based on the following algorithm using the approximate equation indicating the relationship between the relative read value of the image reading section 26 and the voltage correction value.

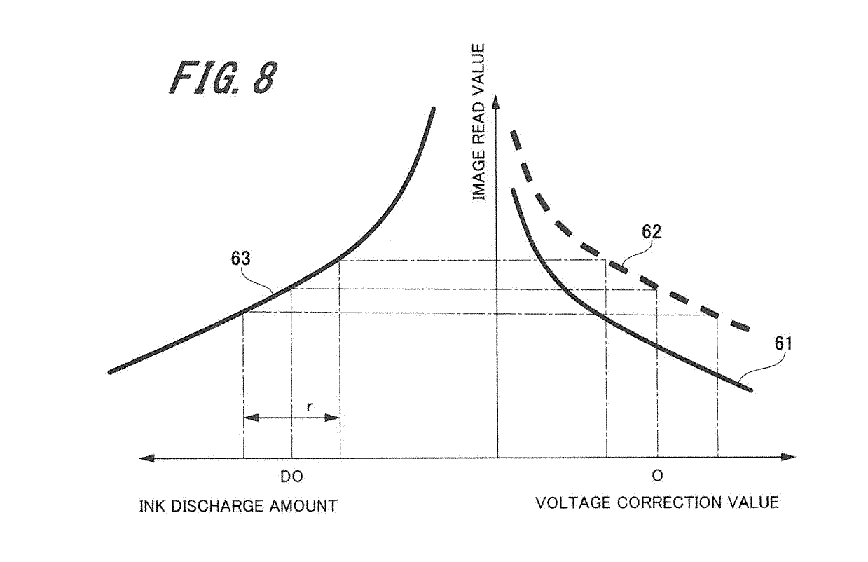

FIG. 8 is a view representing a relationship among the voltage correction value used for setting the drive voltage correction value, the image read value obtained by the image reading section 26, and the ink discharge amount. In the present example, the value read by a CCD sensor of the image reading section 26 is used as the image read value. The CCD data represent values expressed brighter as the read value is made larger, and expressed darker as the read value is made smaller. Accordingly, the relationship between the image read value (curve 61 of FIG. 8) and the voltage correction value (curve 62 of FIG. 8) undergoes transition so that the larger the voltage correction value becomes, the smaller the image read value becomes. Referring to the relationship between the image read value and the ink discharge amount (curve 63 of FIG. 8), the more the ink discharge amount becomes, the higher the density becomes owing to the increase in the coverage factor on the paper. Therefore, the larger the ink discharge amount becomes, the smaller the image read value becomes. Referring to FIG. 8, the ink discharge amount and the image read value are uniquely determined. Concerning the relationship between the voltage correction value and the image read value, as the discharge sensitivity is different among the recording heads 242a to 242f, a plurality of lines are formed for the respective recording heads. The curves 61, 62 indicated by the solid line and the broken line, respectively represent the relationship between the densities of the images printed by two of the recording heads 242a to 242f and the image read values. The different voltage correction values are preliminarily applied to record a plurality of test charts by the head units 24, and the ink discharge amounts at the points on the respective test charts in the nozzle array direction are plotted relative to the applied voltage correction values (correction difference) so that the curves 61, 62 are formed. The curve 63 is preliminarily obtained with respect to the recording head 242 having the liquid amount preliminarily managed.

The storage section 44 of the control unit 40 stores data indicating the approximate equation (relational expression) of the curve 61. It is possible to allow the storage section 44 to store the relationship between the voltage correction value and the ink discharge amount as table data in place of the above-described approximate equation so that the voltage correction value is set in reference to the table data.

The control unit 40, more specifically, the CPU 41 controls execution of printing of the test charts, derivation of the approximate equation, and generation of the table data. It is also possible to allow the external device 2 to execute derivation of the approximate equation and generation of the table data.

Referring to FIG. 8, the curve 62 represented by the broken line is formed through parallel shifting of the curve 61 in the Y-axis direction relative to the ink discharge amount. The curve 62 represents the relationship between the voltage correction value for the specific part of the nozzle groups of the recording heads 242a to 242f, and the average value of the ink discharge amount. The specific part may be a part of the nozzle groups (joint part between the nozzle groups), the entire nozzle group of one of the recording heads 242, or entire nozzle groups of all the recording heads 242. As described above, the relationship between the ink discharge amount at each part of the head unit 24, and the voltage correction value may be expressed by the curve obtained through parallel shifting of the curve 61 in the Y-axis direction.

The curve 62 shown in FIG. 8 represents an example that the average value of the ink discharge amount becomes D1 upon discharge of the ink while having the voltage correction value set to 0. Among the points on the curve 62, the X-axis coordinate of the point having the Y-axis coordinate coincided with the target value of the adjusted ink discharge amount represents the voltage correction value corresponding to the adjusted ink discharge amount. For example, if the ink discharge amount is adjusted so that the average value of the ink discharge amount at the specific part of the nozzle groups with property as indicated by the curve 62 becomes the reference value D0, the voltage correction value V1 corresponding to the point on the curve 62, at which the ink discharge amount becomes the reference value D0 is obtained and set as the drive voltage correction value corresponding to the drive voltage of the recording head 242.

In the state where the voltage correction value is set so that the predictive values of the ink discharge amount have the distribution as shown in FIG. 7A, each average value of the ink discharge amounts 60a to 60f of the corresponding recording heads 242 coincides with the reference value D0. However, the difference in the ink discharge amount is observed at each joint part between the nozzle groups. In other words, at the joint part between the nozzle group of the recording head 242a and the nozzle group of the recording head 242b, the divergence is observed between the representative values of the ink discharge amounts 60a and 60b at the joint part by the amount corresponding to ΔD1. This applies to the representative values of the ink discharge amounts at the respective joint parts between the sequentially arranged recording heads 242 in the nozzle array direction by the amounts corresponding to ΔD2 to ΔD5, respectively.

It is possible to set the average value or the median of the ink discharge amount at the joint part as the representative value. If the magnitude of the divergence (difference) exceeds the upper limit value of the range in which such a divergence is not visually recognized as the density unevenness, the density unevenness may be visually recognized at the part of the recorded image corresponding to the joint part between the nozzle groups. Based on the above-described algorithm, the voltage correction values of the recording heads 242b to 242f are changed and set so that each difference of the representative values of the ink discharge amounts of the nozzle groups (ΔD1 to ΔD5) at the respective joint parts between the nozzle groups becomes zero.

For example, if the average value of the ink discharge amount of the entire nozzle group of the recording head 242 with the property as indicated by the curve 62 shown in FIG. 8 is adjusted to D2 so as to set the difference between the representative values of the ink discharge amounts at the joint part to zero, the voltage correction value V2 corresponding to the point on the curve 62, at which the ink discharge amount becomes D2 is obtained and set as the drive voltage correction value of the subject recording head 242.

Alternatively, it is possible to set the voltage correction value so that the difference of the representative values of the ink discharge amounts between the respective nozzle groups at the joint parts satisfies the predetermined continuity condition. The predetermined continuity condition may be established if the difference of the representative values of the ink discharge amounts between the nozzle groups at the joint part is within a range of the predetermined reference difference value. Preferably, the predetermined reference difference value is set to be a large value sufficient to facilitate setting of the voltage correction value of the recording head 242 within a range in which the density unevenness of the recorded image at the region corresponding to the joint part is not visually recognized, or inconspicuous.

FIG. 7B represents predictive values of the ink discharge amounts 60a to 60f obtained based on the thus set voltage correction values in the case where the density measuring test chart is printed by the head unit 24.

Referring to FIG. 7B, continuity is observed in the ink discharge amounts at the joint parts between the respective nozzle groups. Continuity in the ink discharge amounts results in accumulation of the ink by the amount corresponding to the differences of the ink discharge amounts at both ends of the nozzle groups of the respective recording heads 242 in the nozzle array direction. This may cause the ink discharge amount of a part of the recording head 242 to largely diverge from the reference value D0, thus exceeding the reference range r.

The example shown in FIG. 7B represents that at least each part of the ink discharge amounts 60a to 60f corresponding to the recording heads 242b to 242f has the value deviating from the reference range r. The voltage correction values of the respective recording heads 242a to 242f are changed and set to allow the total average value (representative value) of the ink discharge amounts 60a to 60f corresponding to the recording heads 242a to 242f to coincide with the reference value D0 so that the ink discharge amount of more part of the nozzle groups of the recording heads 242a to 242f falls within the reference range r.

FIG. 7C represents predictive values of the ink discharge amounts 60a to 60f obtained based on the thus set voltage correction values in the case where the density measuring test chart is printed by the head unit 24.

Operations for adjusting the ink discharge amounts (dot diameter) corresponding to FIGS. 7A to 7C constitute the first density correction operation. Specifically, in the first density correction operation, based on the average density of the test charts of the respective nozzle groups in the recording heads 242, the conditions for driving the respective recording heads 242 are set so that the average density values become uniform among the nozzle groups in the recording heads.

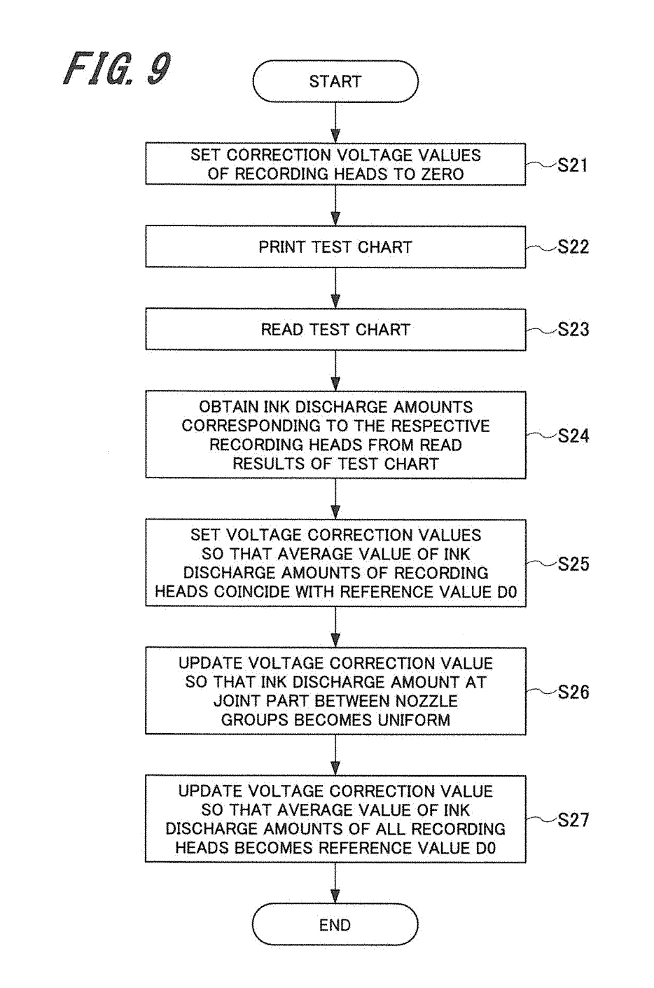

The flow of the first density correction operation will be described. FIG. 9 is a flowchart representing the flow of the first density correction operation. The first density correction operation is executed under the control of the control unit 40, more specifically, the CPU 41 (see FIG. 3) constituting the control unit 40.

Upon start of executing the first density correction operation, the CPU 41 sets the voltage correction values corresponding to the respective recording heads 242 to zero, and allows the storage section 44 to store the set value (step S21). Then the head unit 24 is controlled to print the density measuring test chart on the recording paper P (step S22).

In the process to be executed in step S22, the CPU 41 outputs the control signal to the carrier drive section 51, which drives the image forming drum 21 to be rotated for carrying the recording paper P. The CPU 41 supplies the control signal which contains the image data of the test chart stored in the ROM 43 to the head drive unit 241 so as to be allowed to output the drive voltage to the recording head 242 at the appropriate timing adapted to the rotation of the image forming drum 21. As the ink droplets are discharged from the nozzles 244 of the recording heads 242 onto the recording paper P to be carried by the image forming drum 21, the test chart is printed on the recording paper P.

The CPU 41 controls the image reading section 26 to read the density of the test chart printed on the recording paper P (step S23). Specifically, the CPU 41 allows the image reading section 26 to read the density of the test chart printed on the recording paper P while allowing the image forming drum 21 to carry the recording paper P, obtains the image pickup data read by the image reading section 26, and stores the data in the storage section 44.

The CPU 41 obtains data on the ink amounts discharged from the nozzle groups of the respective recording heads 242 based on the read results of the test charts (image pickup data) (step S24). The CPU 41 generates the ink discharge amount data so as to be stored in the storage section 44.

The CPU 41 sets the voltage correction values corresponding to the respective recording heads 242 so that the average value of the ink discharge amount corresponding to the respective recording heads 242 coincides with the reference value D0 (step S25). Specifically, the CPU 41 calculates the average values of the ink discharge amounts corresponding to the respective recording heads 242 based on the ink discharge amount data. Based on the average values of the ink discharge amounts corresponding to the respective recording heads 242, and the approximate equation indicating the relationship between the ink discharge amount and the voltage correction value, the CPU 41 sets the voltage correction values corresponding to the respective recording heads 242 so that the average values of the ink discharge amounts corresponding to the respective recording heads 242 coincide with the reference value D0. The set values are then stored in the storage section 44.

If it has been preliminarily known that non-uniformity is hardly observed in the ink discharge amounts among the nozzle groups of the respective recording heads 242, and the ink discharge amounts corresponding to the nozzle groups in the nozzle array direction at both ends are consistent with each other, it is possible to end the first density correction operation after execution of the process in step S25. If it has been preliminarily known that the non-uniformity is observed in the ink discharge amount among the nozzle groups, and the ink discharge amounts corresponding to the nozzle groups in the nozzle array direction at both ends are not consistent with each other, it is possible to skip execution of the process in step S25.

The CPU 41 updates the voltage correction values corresponding to the respective recording heads 242 so that the difference in the representative values of the ink discharge amounts between the nozzle groups at the joint part becomes zero (step S26). Specifically, based on the voltage correction value set in step S25, the CPU 41 calculates the difference between the ink discharge amounts at both ends of the nozzle groups of the respective recording heads 242 upon discharge of the ink droplets, and the ink discharge amount at the joint part between the nozzle groups. The CPU 41 then changes the voltage correction values corresponding to the respective recording heads 242 sequentially so that the calculated difference becomes zero, and stores those values in the storage section 44.

The CPU 41 updates the voltage correction values corresponding to the respective recording heads 242 so that the total average value of the ink discharge amounts of all the recording heads 242 becomes the reference value D0 (step S27). Specifically, based on the voltage correction values set in step S26, the CPU 41 calculates the total average value of the ink discharge amounts corresponding to all the recording heads 242 upon discharge of the ink droplets. The CPU 41 sets the voltage correction values corresponding to the respective recording heads 242, and stores those values in the storage section 44 so that the average value coincides with the reference value D0, that is, the ink discharge amounts corresponding to the respective recording heads 242 shift by the amount equivalent to the difference between the average value and the reference value D0.

As described above, based on the density information of the recording heads 242 derived from execution of the first density correction operation, that is, reading of the test chart, conditions for driving the respective recording heads 242 are calculated to end a series of process steps for setting the subject drive conditions for the recording heads 242. The first density correction operation is executed for correction so that the density of the image formed on the recording paper P becomes uniform as a whole. Even if the density is uniform as a whole as the dot ratio becomes higher, divergence of gloss feel is more likely to be observed between the carrying direction of the recording paper P and the nozzle array direction orthogonal to the carrying direction. In other words, the first density correction operation secures to correct the density values uniform, but may result in images each with different glossiness owing to the respective recording heads 242.

The process proceeds to the second density correction operation after execution of the first density correction operation so as to suppress image quality deterioration as a result of the glossiness feel difference among the recording heads 242. In other words, the first density correction operation is executed for correction so that the overall density is made uniform. Thereafter, the second density correction operation is executed to correct the glossiness unevenness.

### (Second Density Correction Operation)

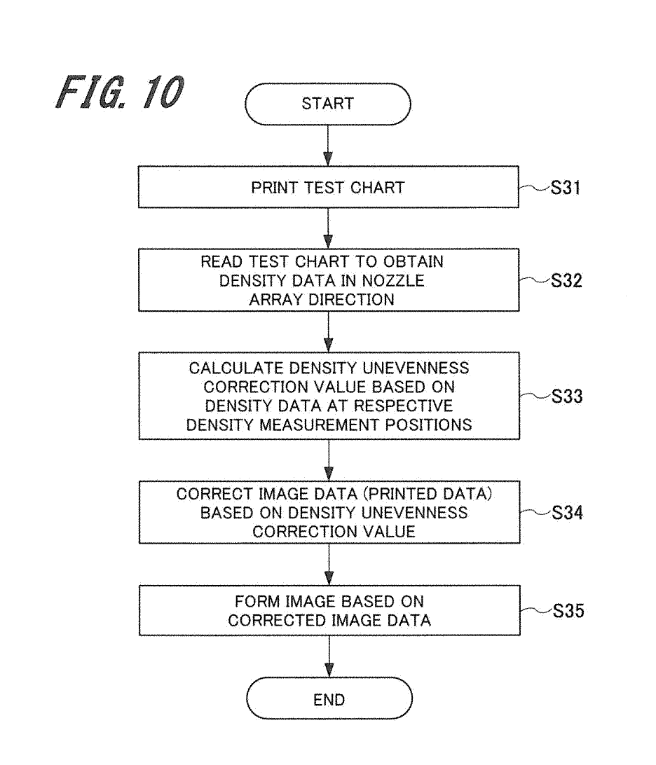

An explanation will be made with respect to the flow of the second density correction operation for adjusting the discharge amount of the ink droplets from the nozzles 244 of the recording head 242. FIG. 10 is a flowchart representing the flow of the second density correction process. Likewise the first density correction operation, the second density correction operation is executed under the control of the CPU 41 (see FIG. 3) constituting the control unit 40.

At the end of the first density correction operation, the CPU 41 controls the head units 24 to print the density measuring test chart on the recording paper P (step S31). The density measuring test chart to be printed upon execution of the second density correction operation may be the same as or different from the one that has been printed upon execution of the first density correction operation.

The CPU 41 controls the image reading section 26 to read the density of the test chart printed on the recording paper P, and obtains the density data in the nozzle array direction (step S32). Then a density unevenness correction value is calculated based on the density data at each position at which the density is measured by the image reading section 26 (step S33).

The density unevenness correction value may be calculated in reference to the resolution conversion curve indicating the correlation between the pixel position (density measurement position) of the image reading section 26, and the nozzle position. Specifically, based on the resolution conversion curve, the measurement density values for the respective density measurement positions are converted into the density data at the respective nozzle positions so that the difference between the density data and the target density value is calculated. Based on the curve indicating the correlation between the pixel value and the density value, the difference between the density data and the target density value is converted into the pixel value difference. The pixel value difference becomes the density unevenness correction value.

The CPU 41 corrects the image data (printed data) based on the density unevenness correction value calculated in step S33 (step S34), and forms an image on the recording paper P based on the corrected image data (step S35).

As described above, the first density correction operation is executed to change the drive conditions for the recording heads 242, and adjust the dot diameter for correction so that the density of the image formed on the recording paper P is made uniform. Thereafter, the second density correction operation is executed to correct the image data for the dot ratio adjustment. This may cope with the glossiness unevenness exhibiting different gloss feel among the respective recording heads 242. It is therefore possible to achieve both high quality of the image formed on the recording paper P, and the natural gloss feel.

### Modified Example

The present invention has been described in reference to the embodiment, which is not limited to the range covered by the embodiment. It is possible to arbitrarily make variations or modifications of the embodiment so as not to deviate from the scope of the present invention. The varied or modified modes may also be included in the scope of the present invention from the technological aspects. The scope of the present invention should be interpreted by terms of the appended claims.

For example, in the above-described embodiments, the paper is employed as the recording medium, which is not limited thereto. It is possible to employ various kinds of recording media, for example, a cloth, a plastic film, a glass plate and the like.

In the embodiments, the drum type ink-jet recording apparatus using the image forming drum 21 for carrying the recording medium has been explained, which is not limited thereto. The present invention is applicable to the belt-type ink-jet recording apparatus using the endless carrier belt.

### REFERENCE SIGNS LIST

1. ink-jet recording apparatus
2. external device
10. paper feed unit
20. image forming unit
21. image forming drum
23. heater
24. head unit
25. fixing section
26. image reading section
27. paper ejection section
28. paper reversing section
30. paper discharge unit
40. control unit
41. CPU
42. RAM
43. ROM
44. storage section
51. carrier drive section
52. operation display section
53. I/O interface
54. system bus
242. recording head
244. nozzle
401. first density correction unit
402. second density correction unit
P. paper (recording medium)

What is claimed is:

1. An ink-jet recording apparatus comprising:
a recording unit for printing an image on a recording medium by discharging ink droplets from a plurality of nozzles of a plurality of recording heads;
an image reading section for reading a density of a density measuring test chart printed on the recording medium by the recording unit; and
a control unit for controlling a density correction based on a result of reading by the image reading section,
wherein the control unit executes a function of a first density correction by calculating drive conditions for the respective recording heads based on density information of the recording heads derived from the test chart read by the image reading section so that the drive conditions are set for the recording heads, and a function of a second density correction by calculating a density unevenness correction value based on the density information derived from the test chart that has been printed by the recording unit again after execution of the first density correction, and read by the image reading section so that the image data are corrected based on the density unevenness correction value.

2. The ink-jet recording apparatus according to claim 1, wherein:
the test chart is printed for each of nozzle groups in the recording heads, for which the same drive conditions are set; and
the control unit executes the first density correction to set the drive conditions based on an average density of the test charts corresponding to the respective nozzle groups.

3. The ink-jet recording apparatus according to claim 2, wherein the control unit sets the drive conditions so that the average density of the test charts corresponding to the respective nozzle groups is made uniform among the nozzle groups in the recording heads.

4. The ink-jet recording apparatus according to claim 1, wherein a reading resolution of the image reading section in a nozzle array direction is set to be lower than a recording resolution of the recording head.

5. The ink-jet recording apparatus according to claim 1, wherein the density measuring test chart is a gray scale test chart.

6. A density correction method for an ink-jet recording apparatus, the ink-jet recording apparatus including a recording unit for printing an image on a recording medium by discharging ink droplets from a plurality of nozzles of a plurality of recording heads, and an image reading section for reading a density of a density measuring test chart printed on the recording medium by the recording unit so that a density correction is executed based on a read result of the image reading section, the density correction method executing operations of:
a first density correction by calculating drive conditions for the respective recording heads based on density information of the recording heads derived from the test chart read by the image reading section so that the drive conditions are set for the recording heads; and
a second density correction by calculating a density unevenness correction value based on the density information derived from the test chart that has been printed by the recording unit again after execution of the first density correction, and read by the image reading section so that the image data are corrected based on the density unevenness correction value.
